(19) United States
(12) Patent Application Publication
(10) Pub. No.: US 2005/0051676 A1
(43) Pub. Date: Mar. 10, 2005

(54) Mounting cable tie with screw inserted into head

(76) Inventors: James Del Sordo JR., East Brandywine, PA (US); Todd McClure, Parkesburg, PA (US); James Del Sordo SR., Harrisburg, PA (US)

Correspondence Address: Anthony R. Carlis Esq., 34 Kkristin Circle, Downingtown, PA, 19335, US

(21) Appl. No.: 10/935,443

(22) Filed: Sep. 7, 2004

Related U.S. Application Data
(60) Provisional application No. 60/481,337, filed on Sep. 5, 2003.

(51) Int. Cl. F16L 3/00

(52) U.S. Cl. 248/74.3

(57) ABSTRACT

A mountable cable (wire) tie with a screw pre-inserted into screw holder position. The pre-inserted screw allows a user to more quickly and more easily bundle wires and attach the wires to a mounting point via the screw mount cable (wire) tie.

### CROSS REFERENCE TO RELATED APPLICATION(S)

This application claims priority from U.S. provisional application No. 60/481,337 which was filed on Sep. 5, 2003 which is incorporated by reference as if fully set forth.

### SUMMARY

A screw or any other fastener mount cable (wire) tie with a screw pre-inserted into screw holder position. The pre-inserted screw allows a user to more quickly and more easily bundle wires and attach the wires to a mounting point via the screw mount cable (wire) tie.

### BACKGROUND OF THE INVENTION

The need to assemble, contain and control multiple wires into tightly organized bundles appeared with the invention of the first products that contained electrical wiring systems. Wiring had to be bundled and routed within equipment to prevent or reduce damage to wiring, isolate the wires from moving parts and to provide a consistent, organized and efficient wiring layout to help tracing and servicing of internal wiring systems.

In early products with electrical wiring. the methods for securing and routing wiring were simple. Manufacturers utilized twine, lacing cord or friction tape to bundle and route the wiring. Although these materials were effective in prototype and early production units, it became clear that they had serious drawbacks as bundling devices. Hand wrapping of lacing cord required a great deal of time in manufacturing and tying off did not produce a very secure and tight bundle. There was the danger that thin cord would cut into wire insulation, while tapes could dry out and peel off.

These problems triggered efforts to invent a device that would encircle bundle and route wires more efficiently and at uniform tension. Some early prototype devices included separate straps and locking mechanisms, which required two operations to install. All these devices lacked fine adjustment and permanent locking features.

The first device that was used to bundle and route wires effectively were similar in appearance and function to today's standard cable (wire) tie. It had a steel pawl or barb inserted at an angle inside its head. Although this design provided fine adjustment and self-locking it required two separate, time consuming manufacturing operations—molding the tie and insertion of the steel pawl. In addition, there was the possibility that the steel pawl could work loose or break off, with potentially disastrous results if it fell into printed circuits or closely spaced relay contacts.

The next major development was a two-component, self-locking cable (wire) tie completely produced from nylon material. Although it was finely adjustable, it still maintained the time-consuming, two-step manufacturing process. Because of its design, this improved cable (wire) tie provided better hand-eye coordination and reduced installation time. Over time, cable (wire) tie design improved steadily and eventually led to the development of a one-piece, molded, self-locking nylon cable (wire) tie.

Since the development of the first one-piece, self-locking cable (wire) tie ,its design was steadily refined to improve the effectiveness of the product as a wire bundling device. The basic one-piece, self-locking cable (wire) tie now comes in many sizes and styles for a diverse range of applications. It has also been modified into specialty ties with all the qualities of the basic tie, plus added features for different uses.

One of the added features is the addition of a screw whole which allows the user to insert a screw into the cable (wire) tie and mount the bundled cables. Several problems can occur with its use. For example, the user may not be able to find the correct screw (or any screw) to mount the cable (wire) tie. Another problem occurs when the user has trouble holding the mounting screw in the cable (wire) tie while attaching the cable (wire) tie to its application.

Therefore it would be desirable to have a screw mount cable (wire) tie with a screw inserted. The said screw should be attached to said screw mount cable (wire) tie until the user attaches the screw mount cable (wire) tie to its application.

### BRIEF DESCRIPTION OF THE DRAWING(S)

FIG. 1 illustrates a screw mount wire tie with a screw attached.

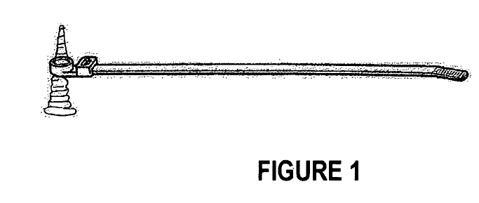

### DETAILED DESCRIPTION OF THE PREFERRED EMBODIMENT(S)

A screw mount cable (wire) tie allows the user to bundle cable or wires and easily mount the bundle to an application. To aid the user, the cable (wire) tie would have a screw inserted into a screw mount hole.

In a first embodiment, the screw would be held in place with a felt or plastic retainer. The felt retainer would have little or no impact on the operation of the screw mount cable (wire) tie.

In a second embodiment, the screw could be “snugged” into the screw mount hole. The cable (wire) tie's mounting screw hole would be slightly smaller than the outside diameter of a mounting screw. Said screw would be inserted by a manufacturing process at the time the cable (wire) tie is produced or at a post cable (wire) tie production assembly.

1. A screw mount cable (wire) tie with a means to hold a mounting screw in a screw mounting hole in said screw mount cable (wire) tie.

2. The screw mount cable (wire) tie in claim 1 wherein said screw is plastic, nylon, or metal.

3. The screw mount cable (wire) tie in claim 1 wherein said screw mount cable (wire) tie is plastic, nylon, or metal.

4. The screw mount cable (wire) tie in claim 1 wherein said screw is replaced with another type of fastener, such as nail, clevis pin or adhesive backing.
